(19) United States
(12) Patent Application Publication
(10) Pub. No.: US 2026/0220181 A1
(43) Pub. Date: Jul. 30, 2026

(54) METHOD AND SYSTEM FOR ADDING DIRECT INTERACTION FOR STATIC VISUALIZATION

(71) Applicant: PEKING UNIVERSITY, Beijing (CN)

(72) Inventors: Xiaoru YUAN, Beijing (CN); Can LIU, Beijing (CN); Yu ZHANG, Beijing (CN); Cong WU, Beijing (CN); Chen LI, Beijing (CN)

(73) Assignee: PEKING UNIVERSITY, Beijing (CN)

(21) Appl. No.: 19/144,545

(22) PCT Filed: Nov. 27, 2023
(86) PCT No.: PCT/CN2023/134269

§ 371 Date: Aug. 29, 2025

(30) Foreign Application Priority Data
Dec. 30, 2022 (CN) 202211742307.X

(51) Int. Cl. G06F 16/34

(52) U.S. Cl. CPC G06F 16/34

(57) ABSTRACT

A method and system for adding a direct interaction to a static visualization belongs to the field of visualization. The method includes: deconstructing a common visualization spatial layout into an atomic spatial constraint; taking an initial chart as input, and inferring an original spatial constraint of the common visualization spatial layout from an existing visualization chart; and calculating a post-interaction spatial constraint based on the inferred original spatial constraint of the visualization layout and a received user interaction instruction, where the post-interaction spatial constraint is configured to drive visualization elements to balance to a new spatial layout. The method aims to solve the problem that current visualizations lack interactions or are not interpretable. The method applies four basic spatial constraints to model common visualizations, enabling diverse visualization interactions, thereby achieving strong practicability and laying a robust foundation for the development of visualization.

### CROSS REFERENCE TO THE RELATED APPLICATIONS

This application is the national phase entry of International Application No. PCT/CN2023/134269, filed on Nov. 27, 2023, which is based upon and claims priority to Chinese Patent Application No. 202211742307.X, filed on Dec. 30, 2022, the entire contents of which are incorporated herein by reference.

### TECHNICAL FIELD

The present disclosure belongs to the field of visualization, and specifically relates to a method and system for adding a direct interaction to a static visualization.

### BACKGROUND

Visualization is an important means to express data in the data era. Interactions in visualizations enable output to adapt to user intents, thereby accomplishing diverse tasks on demand. However, technology that allows creators to implement visualization interactions is complex and time-consuming, and the interactions are difficult to understand for users. Consequently, a large number of visualizations lack interactions or the interactions are inaccessible to users.

### SUMMARY

In view of the defects in the prior art, an objective of the present disclosure is to provide a method and system for adding a direct interaction to a static visualization. The present disclosure adds an interaction to an existing static visualization or an interaction-lacking visualization and constructs an interaction method easily understood for users, thereby supporting users to accomplish a broader range of tasks.

To achieve the above objective, the technical solutions adopted by the present disclosure are as follows. In a first aspect, a method for adding a direct interaction to a static visualization includes following steps:
S1: deconstructing a common visualization spatial layout into an atomic spatial constraint;
S2: taking an initial chart as input, and inferring an original spatial constraint of the common visualization spatial layout from an existing visualization chart; and
S3: calculating a post-interaction spatial constraint based on the inferred original spatial constraint of the visualization layout and a received user interaction instruction, where the post-interaction spatial constraint is configured to drive visualization elements to balance to a new spatial layout.

Furthermore, in the step S1, the atomic spatial constraint includes a support force and an attraction force from an external environment of elements, a collision force between the elements, and a fixed force within the elements.

Furthermore, the step S2 includes: inferring the original spatial constraint based on an element type and spatial position of the visualization chart; and the step S2 includes following sub-steps:
S21: extracting a spatial constraint control point from the existing visualization chart;
S22: applying a fixed constraint to the extracted spatial constraint control point;
S23: identifying a baseline axis based on the spatial constraint control point;
S24: applying the support force and the attraction force to the visualization elements based on the identified baseline axis;
S25: determining whether a collision relationship exists; and
S26: applying a collision constraint if the collision relationship exists.

Furthermore, in the step S3, the interaction instruction includes a direct interaction with the visualization elements, a direct interaction with a visualization axis, and a direct interaction with a visualization constraint.

Furthermore, for the direct interaction with the visualization elements, different control point and constraint changes are set based on signal instructions of a user for different drag directions and magnitudes, and after dragging ends, the post-interaction spatial constraint drives the visualization elements to balance to the new spatial layout.

Furthermore, for the direct interaction with the visualization axis, the visualization constraint is adjusted based on a signal instruction of a user for zooming or reordering the axis, and the post-interaction spatial constraint drives the visualization elements to balance to the new spatial layout.

Furthermore, for the direct interaction with the visualization constraint, a user instruction is converted to adjust a constraint of an original visualization element or a new constraint is set for a selected visualization element, and the new constraint drives the visualization elements to balance to the new spatial layout.

Furthermore, the step S1 includes: deconstructing a spatial constraint of a bar chart as including a baseline axis configured to support bars, where all the bars are subjected to a support constraint and an attraction constraint perpendicular to the axis and from the axis, and are subjected to fixed constraints in a same horizontal direction and a same vertical direction within the bars.

Furthermore, the step S1 includes: deconstructing a spatial constraint of an area chart as including a baseline axis configured to support area elements, where all the area elements are subjected to a support constraint and an attraction constraint from the axis, and a fixed constraint is applied between control points at a same vertical position on the baseline axis.

In a second aspect, a system for adding a direct interaction to a static visualization is configured to add a direct interaction to a static visualization by using the method for adding a direct interaction to a static visualization in the first aspect of the present disclosure and any optional implementation thereof.

The present disclosure has following beneficial technical effects. The present disclosure provides a method and system for adding a direct interaction to a static visualization. The present disclosure aims to solve the problem that current visualizations lack interactions or are not interpretable. The present disclosure applies four basic spatial constraints to model common visualizations, thereby enabling diverse visualization interactions.

### BRIEF DESCRIPTION OF THE DRAWINGS

FIG. 1 is a flowchart of a method for adding a direct interaction to a static visualization according to Embodiment 1 of the present disclosure;

FIG. 2 is a schematic diagram showing deconstruction of four atomic spatial constraints and common visualizations in the method for adding a direct interaction to a static visualization according to Embodiment 1 of the present disclosure;

FIG. 3 is a schematic diagram showing direct interactions supported by the spatial constraints and corresponding results in the method for adding a direct interaction to a static visualization according to Embodiment 1 of the present disclosure;

FIG. 4 is a schematic diagram showing a process of constructing a spatial constraint and adding a direct interaction to a static stacked area chart in the method for adding a direct interaction to a static visualization according to Embodiment 1 of the present disclosure; and

FIG. 5 is a schematic diagram showing a process of adding a direct interaction to a bubble chart in the method for adding a direct interaction to a static visualization according to Embodiment 1 of the present disclosure.

### DETAILED DESCRIPTION OF THE EMBODIMENTS

The present disclosure is further described below with reference to the drawings and specific implementations.

### Embodiment 1

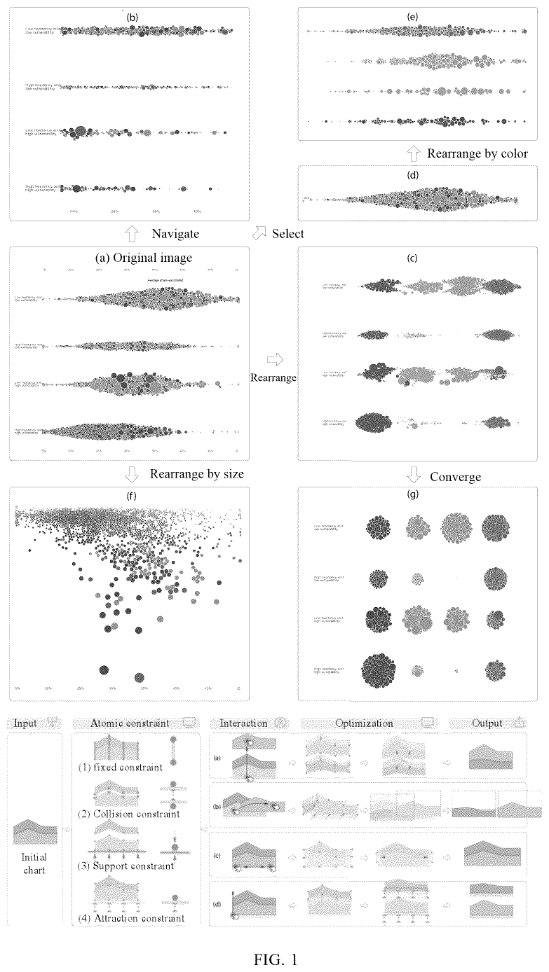

As shown in FIG. 1, the embodiment of the present disclosure provides a method for adding a direct interaction to a static visualization, including following steps.
S1. A common visualization spatial layout is deconstructed into an atomic spatial constraint.

An element in an existing visualization is regarded as being subjected to multiple different types of spatial constraints (forces), including a support force and an attraction force from an external environment of elements, a collision force between the elements, and a fixed force within the elements. The support force is commonly applied by an axis onto the element, for example, an axis in a bar chart or an area chart supports a visualization. The attraction force exists in the attraction of the axis to the visualization element or in the attraction of an axis value to the visualization element. The collision force maintains a relationship between elements, such as a stacking relationship between different elements in a stacked area chart. The fixed force maintains a shape of the visualization element, such as a force keeping the shape of a rectangle in a bar chart along an internal side. These types of four forces correspond to a support constraint, an attraction constraint, a collision constraint, and a fixed constraint. These four types of constraints can model elements of common visualizations and are therefore defined as atomic spatial constraints. The basic unit for modeling spatial constraints is a control point. The control point can represent point elements, with a connection representing line elements and an enclosed area representing area elements.

The spatial constraints of a bar chart can be deconstructed as including a baseline axis configured to support bars. All bars are subjected to support and attraction constraints perpendicular to the axis and from this axis, and are subjected to fixed constraints in a same horizontal direction and a same vertical direction within the bars. Specifically, in a stacked bar chart, stacked bars are subjected to collision constraints. In a grouped bar chart, a group of bars are subjected to collision constraints parallel to the baseline axis.

The spatial constraints of an area chart can be deconstructed as including a baseline axis configured to support area elements. All the area elements are subjected to a support constraint and an attraction constraint from the axis, and a fixed constraint is applied between control points at a same vertical position on the baseline axis. Specifically, stacked area charts have collision constraints between control points of different visualization elements at the same vertical position on the baseline axis.

The spatial constraints of a bubble chart can be deconstructed as including collision constraints between bubbles to ensure non-overlap, in addition to support or attraction forces that may exist.

Scatter plots and line charts can be deconstructed as including attraction constraints at original positions in two directions.

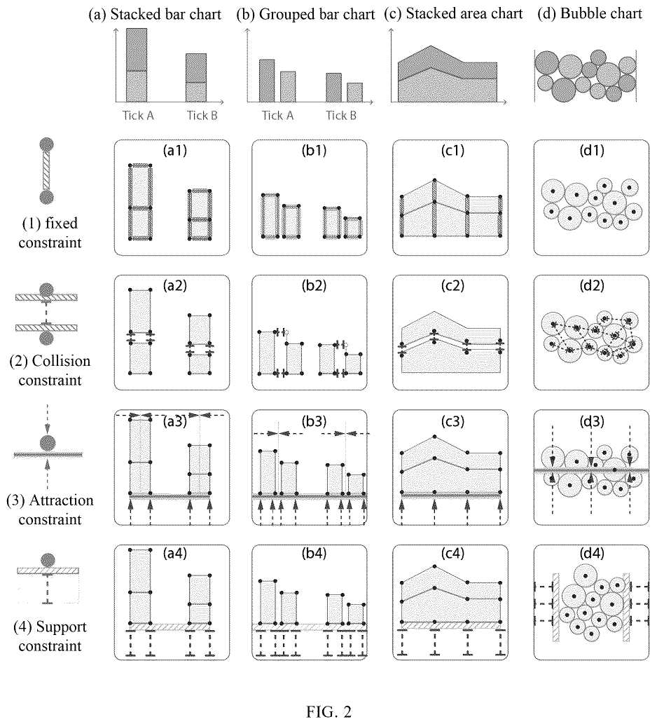

As shown in FIG. 2, (a1) and (b1) show fixed constraints within bars to maintain their shape. In (a2), the stacked bar chart has collision constraints at vertical positions to ensure non-overlap between upper and lower elements. Similarly, in (c1), the stacked area chart has collision constraints between upper and lower elements to ensure non-overlap in the vertical direction. The grouped bar chart achieves non-overlap in the horizontal direction (as shown in (b2)), with collision constraints between bars of the same group in the horizontal direction. The stacked bar charts, grouped bar charts, and stacked area charts all have a baseline axis for supporting and attracting visualization elements, giving them attraction constraints (a3, b3, c3) and support constraints (a4, b4, c4).
S2. An initial chart is taken as input, and an original spatial constraint of the common visualization spatial layout is inferred from an existing visualization chart.

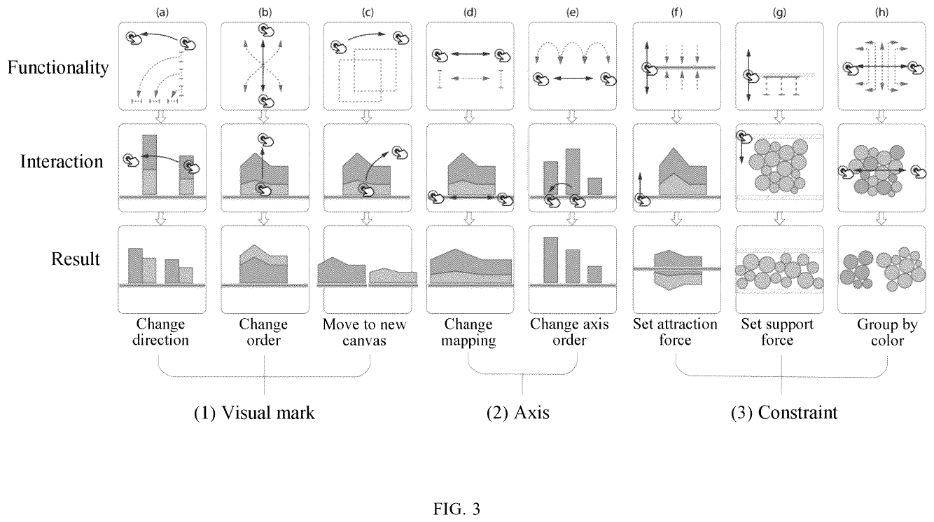

In an existing visualization, the original spatial constraint can be inferred based on the visualization element type and spatial position. The specific process is as follows.
S21. A spatial constraint control point is extracted from the existing visualization.
S22. A fixed constraint is applied to the extracted spatial constraint control point.
S23. A baseline axis is identified based on the spatial constraint control point.
S24. The support force and the attraction force are applied to the visualization elements based on the identified baseline axis.
S25. It is determined whether a collision relationship exists.
S26. A collision constraint is applied if the collision relationship exists.
S3. A post-interaction spatial constraint is calculated based on the inferred original spatial constraint of the visualization layout and a received user interaction instruction, where the post-interaction spatial constraint drives the visualization elements to balance to the new spatial layout. As shown in FIG. 3, direct interaction includes a direct interaction with the visualization elements, a direct interaction with a visualization axis, and a direct interaction with a visualization constraint.

For the direct interaction with a visualization element, the user can arbitrarily drag the element in the visualization to change its position, implying user intent. Different control point and constraint changes are set based on signals of drag direction and magnitude received from the user. After dragging, the constraint drives the visualization element to change according to a physical-world force. The converged visualization element achieves a result of changing stacking direction, altering stacking order, removing an element, and creating a new canvas.

For the direct interaction with the visualization axis, the constraint on the visualization element represents an actual data meaning on the axis. While the axis mapping is changed, the visualization constraint is adjusted, and the change in the visualization element is guided. The user is allowed to zoom a continuous axis and reorder a discrete axis.

For the direct interaction with a visualization constraint, the visualization constraint is displayed via a line with a handle and is interactable with the user. Different visual symbols are set for the attraction constraint and the support constraint. The user can directly adjust the constraint of the original visualization element or set new a constraint for a selected element. The new constraint drives the visualization element to a new spatial layout.

After interaction, the constraint drives the visualization elements to balance to the new spatial layout configured to support visualization tasks including alignment, sorting, filtering, and deletion.

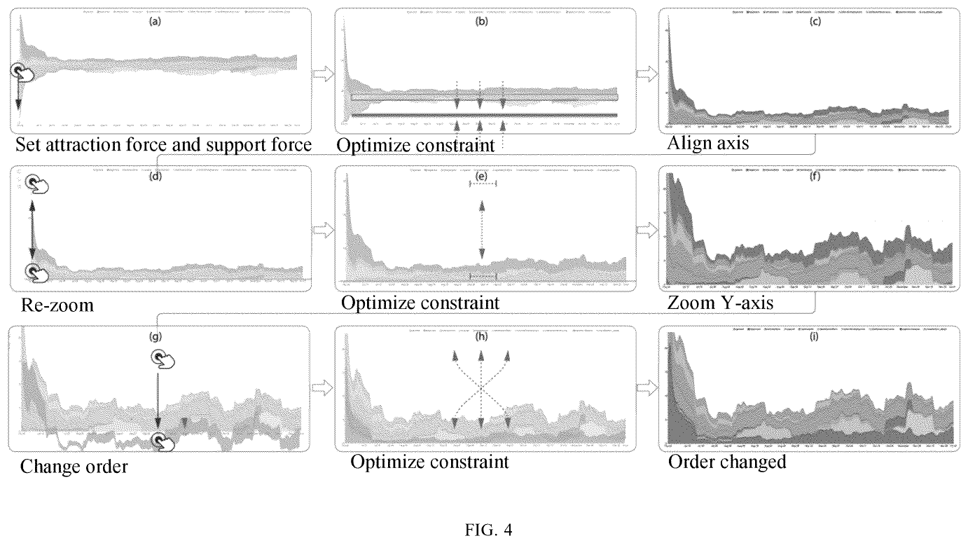

As shown in FIG. 4, spatial constraints are constructed for a static stacked area chart, and the result allows a direct interaction. In (a), (b), and (c), a support constraint and an attraction constraint are set, stacked horizontally. In (d), (e), and (f), the mapping is changed vertically to magnify the visualization element. In (g), (h), and (i), the visualization element is dragged to modify its order.

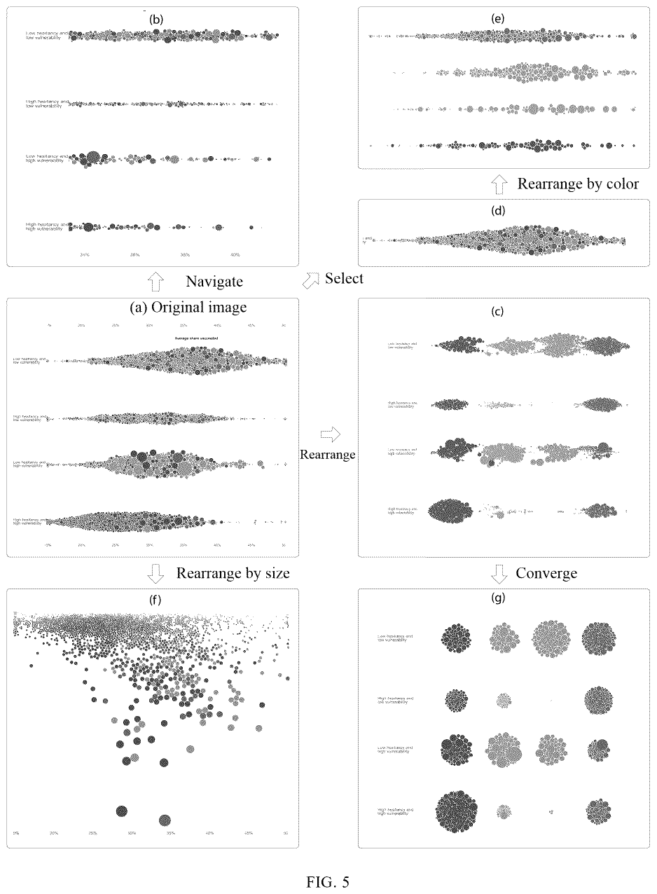

As shown in FIG. 5, starting from an original bubble chart, multiple interactions can be applied. For example, the axis is zoomed for navigation (b). An element of interest is selected (d), and it is rearranged vertically by color (e). Alternatively, starting from the original image, it is rearranged horizontally by color (c) and converged (g). Alternatively, starting from the original image, it is sorted vertically by size.

### Embodiment 2

The embodiment of the present disclosure provides a system for adding a direct interaction to a static visualization. The system adopts the method for adding a direct interaction to a static visualization according to Embodiment 1 and any optional implementation thereof to add a direct interaction to a static visualization chart.

The system models a spatial layout of an existing visualization as a spatial constraint, and the system supports adding a force-metaphor interaction method to an existing visualization.

Through the above embodiments, it can be seen that the present disclosure provides a method and system for adding a direct interaction to a static visualization. In the present disclosure, a common visualization spatial layout is deconstructed into an atomic spatial constraint. An initial chart is taken as input, and an original spatial constraint of the common visualization spatial layout is inferred from an existing visualization chart. A post-interaction spatial constraint is calculated based on the inferred original spatial constraint of the visualization layout and a received user interaction instruction, where the post-interaction spatial constraint drives the visualization elements to balance to the new spatial layout. The present disclosure aims to solve the problem that current visualizations lack interactions or are not interpretable. The method of the present disclosure applies four basic spatial constraints to model common visualizations, thereby enabling diverse visualization interactions. The present disclosure has strong practicability and lays a robust foundation for the development of visualization.

The method and system of the present disclosure are not limited to the embodiments in the detailed description. All other implementations obtained by those skilled in the art according to the technical solutions of the present disclosure should also fall within the technological innovation scope of the present disclosure.

What is claimed is:

1. A method for adding a direct interaction to a static visualization, comprising following steps:
S1: deconstructing a common visualization spatial layout into an atomic spatial constraint;
S2: taking an initial chart as input, and inferring an original spatial constraint of the common visualization spatial layout from an existing visualization chart; and
S3: calculating a post-interaction spatial constraint based on the original spatial constraint of the common visualization spatial layout and a received user interaction instruction, wherein the post-interaction spatial constraint is configured to drive visualization elements to balance to a new spatial layout.

2. The method according to claim 1, wherein in the step S1, the atomic spatial constraint comprises a support force and an attraction force from an external environment of elements, a collision force between the elements, and a fixed force within the elements.

3. The method according to claim 2, wherein the step S2 comprises: inferring the original spatial constraint based on an element type and spatial position of the existing visualization chart; and
the step S2 comprises following sub-steps:
S21: extracting a spatial constraint control point from the existing visualization chart;
S22: applying a fixed constraint to the spatial constraint control point;
S23: identifying a baseline axis based on the spatial constraint control point;
S24: applying the support force and the attraction force to the visualization elements based on the baseline axis;
S25: determining whether a collision relationship exists; and
S26: applying a collision constraint if when the collision relationship exists.

4. The method according to claim 3, wherein in the step S3, the received user interaction instruction comprises a direct interaction with the visualization elements, a direct interaction with a visualization axis, and a direct interaction with a visualization constraint.

5. The method according to claim 4, wherein for the direct interaction with the visualization elements, different control point and constraint changes are set based on signal instructions of a user for different drag directions and magnitudes, and after dragging ends, the post-interaction spatial constraint drives the visualization elements to balance to the new spatial layout.

6. The method according to claim 4, wherein for the direct interaction with the visualization axis, the visualization constraint is adjusted based on a signal instruction of a user for zooming or reordering the visualization axis, and the post-interaction spatial constraint drives the visualization elements to balance to the new spatial layout.

7. The method according to claim 4, wherein for the direct interaction with the visualization constraint, a user instruction is converted to adjust a constraint of an original visualization element or a new constraint is set for a selected visualization element, and the new constraint drives the visualization elements to balance to the new spatial layout.

8. The method according to claim 2, wherein the step S1 comprises: deconstructing a spatial constraint of a bar chart as comprising a baseline axis configured to support bars, wherein all the bars are subjected to a support constraint and an attraction constraint perpendicular to the baseline axis and from the baseline axis, and are subjected to fixed constraints in a same horizontal direction and a same vertical direction within the bars.

9. The method according to claim 2, wherein the step S1 comprises: deconstructing a spatial constraint of an area chart as comprising a baseline axis configured to support area elements, wherein all the area elements are subjected to a support constraint and an attraction constraint from the baseline axis, and a fixed constraint is applied between control points at a same vertical position on the baseline axis.

10. A system for adding a direct interaction to a static visualization, configured to add the direct interaction to a static visualization chart by using the method according to claim 1.

11. The system according to claim 10, wherein in the step S1 of the method, the atomic spatial constraint comprises a support force and an attraction force from an external environment of elements, a collision force between the elements, and a fixed force within the elements.

12. The system according to claim 11, wherein the step S2 of the method comprises: inferring the original spatial constraint based on an element type and spatial position of the existing visualization chart; and the step S2 comprises following sub-steps:
S21: extracting a spatial constraint control point from the existing visualization chart;
S22: applying a fixed constraint to the spatial constraint control point;
S23: identifying a baseline axis based on the spatial constraint control point;
S24: applying the support force and the attraction force to the visualization elements based on the baseline axis;
S25: determining whether a collision relationship exists; and
S26: applying a collision constraint when the collision relationship exists.

13. The system according to claim 12, wherein in the step S3 of the method, the received user interaction instruction comprises a direct interaction with the visualization elements, a direct interaction with a visualization axis, and a direct interaction with a visualization constraint.

14. The system according to claim 13, wherein in the method, for the direct interaction with the visualization elements, different control point and constraint changes are set based on signal instructions of a user for different drag directions and magnitudes, and after dragging ends, the post-interaction spatial constraint drives the visualization elements to balance to the new spatial layout.

15. The system according to claim 13, wherein in the method, for the direct interaction with the visualization axis, the visualization constraint is adjusted based on a signal instruction of a user for zooming or reordering the visualization axis, and the post-interaction spatial constraint drives the visualization elements to balance to the new spatial layout.

16. The system according to claim 13, wherein in the method, for the direct interaction with the visualization constraint, a user instruction is converted to adjust a constraint of an original visualization element or a new constraint is set for a selected visualization element, and the new constraint drives the visualization elements to balance to the new spatial layout.

17. The system according to claim 11, wherein the step S1 of the method comprises: deconstructing a spatial constraint of a bar chart as comprising a baseline axis configured to support bars, wherein all the bars are subjected to a support constraint and an attraction constraint perpendicular to the baseline axis and from the baseline axis, and are subjected to fixed constraints in a same horizontal direction and a same vertical direction within the bars.

18. The system according to claim 11, wherein the step S1 of the method comprises: deconstructing a spatial constraint of an area chart as comprising a baseline axis configured to support area elements, wherein all the area elements are subjected to a support constraint and an attraction constraint from the baseline axis, and a fixed constraint is applied between control points at a same vertical position on the baseline axis.
